(19) United States
(12) Patent Application Publication
(10) Pub. No.: US 2026/0312414 A1
(43) Pub. Date: Oct. 8, 2026

(54) SYSTEM AND METHOD FOR MANAGING DISTRIBUTED ENERGY RESOURCES USING ELECTRIC VEHICLES

(71) Applicant: AJOU UNIVERSITY INDUSTRY-ACADEMIC COOPERATION FOUNDATION, Gyeonggi-do (KR)

(72) Inventors: JAESUNG JUNG, Gyeonggi-do (KR); SEMI LEE, Gyeonggi-do (KR)

(21) Appl. No.: 19/639,505

(22) Filed: Apr. 6, 2026

(30) Foreign Application Priority Data
Apr. 8, 2025 (KR) 10-2025-0045650

(51) Int. Cl. H02J 3/38; B60L 53/63; B60L 53/64; B60L 53/67; G05B 13/04; H02J 3/32

(52) U.S. Cl. CPC H02J 3/38; B60L 53/63; B60L 53/64; B60L 53/67; G05B 13/04; H02J 3/322

(57) ABSTRACT

A distributed energy resource management system using electric vehicles obtains electric-vehicle flexibility data, approximates the electric-vehicle flexibility data to generate approximate flexibility data, calculates bus flexibility data based thereon, optimizes and allocates flexibility power based on a power flow of a distribution grid, and updates a charging schedule according to priorities of electric vehicles based on the allocated flexibility power.

### CROSS-REFERENCE TO RELATED APPLICATION AND CLAIM OF PRIORITY

This application claims the benefit under 35 U.S.C. § 119 of Korean Patent Application No. 10-2025-0045650 filed on Apr. 8, 2025 in the Korean Intellectual Property Office, the entire disclosure of each of which is incorporated herein by reference for all purposes.

### BACKGROUND

### 1. Field

Embodiments of the present invention relate to a technology for managing distributed energy resources using electric vehicles.

### 2. Description of Related Art

A distributed energy resource management system (DERMS) is a new software system for managing distributed energy resources (DERs; hereinafter, distributed resources) that are increasing in a distribution grid. By integrating various stakeholders through a hierarchical framework and supporting key functions such as translation, aggregation, simplification, and optimization of data, the distributed energy resource management system enables effective management of large-scale distributed resources.

However, conventional technologies to which a distributed energy resource management system has been applied mainly focus on management of traditional distributed resources such as photovoltaic (PV) systems, wind turbines (WTs), energy storage systems (ESSs), and demand resources (DRs). These resources are generally installed at fixed locations where their capacities, generation patterns, and grid connection points are relatively stable and predictable. Accordingly, control variables in such technologies are generally designed from the perspective of distributed resource groups rather than dealing with the inherent characteristics of individual devices.

In contrast, an electric vehicle (EV) is a rapidly growing distributed resource, although it introduces significant uncertainty due to mobility and user-dependent charging requirements. In addition, an electric vehicle may act as a flexible load capable of adjusting demand according to grid conditions and, when Vehicle-to-Grid (V2G) is considered, may also discharge stored energy back to the grid. Such inherent flexibility of electric vehicles may provide significant potential to support grid stability, particularly during peak-demand periods.

However, in order to realize such potential, there is a need for a technology capable of integrating electric vehicles with other distributed resources within a distributed energy resource management system so as to allow coordinated control and optimization.

Examples of related art include Korean Patent Publication No. 10-2017-0082753 (Jul. 17, 2017)

### SUMMARY

According to an exemplary embodiment of the present invention, there is provided a distributed energy resource management system using electric vehicles, the system including: one or more distributed resource aggregation units configured to obtain flexibility data from a distributed resource management unit including one or more electric vehicle charging stations and to generate approximate flexibility data by approximating the obtained flexibility data; one or more bus management units configured to obtain the approximate flexibility data from the one or more distributed resource aggregation units and to calculate flexibility data of a bus based on the obtained approximate flexibility data and pre-stored power data of the bus; and an integrated management unit configured to obtain the flexibility data of the bus from the one or more bus management units and to allocate first flexibility power to the one or more bus management units by optimizing the obtained flexibility data of the bus based on a power flow of a distribution grid, wherein the one or more bus management units calculate second flexibility power to be allocated to the one or more distributed resource aggregation units from the first flexibility power allocated by the integrated management unit using Economic Load Dispatch (ELD), wherein the one or more distributed resource aggregation units calculate third flexibility power to be allocated to the one or more distributed resource management units by mapping the second flexibility power allocated from the bus management unit to pre-stored approximate flexibility data, and wherein the one or more distributed resource management units update a charging schedule according to priorities of electric vehicles connected to the distributed resource management unit based on the third flexibility power allocated from the one or more distributed resource aggregation units.

The one or more distributed resource aggregation units may be configured to generate combination data by combining the obtained flexibility data, generate filtered flexibility data by selecting, from among the generated combination data, combination data having a lowest opportunity cost, and generate the approximate flexibility data by approximating a relationship between flexibility power and opportunity cost of the filtered flexibility data as a quadratic function.

The one or more distributed resource aggregation units may be configured to select, based on combination data included in pre-stored approximate flexibility data, combination data having flexibility power identical to or having a smallest difference from the second flexibility power allocated from the bus management unit, and may allocate third flexibility power to the one or more distributed resource management units based on the selected combination data.

The one or more distributed resource aggregation units may be configured to allocate the third flexibility power as positive flexibility power when the flexibility power of the selected combination data is greater than or equal to the second flexibility power, and may allocate the third flexibility power as negative flexibility power when the flexibility power of the selected combination data is less than the second flexibility power.

The integrated management unit may be configured to optimize the obtained flexibility data of the bus so as to satisfy Equation 1 below based on Optimal Power Flow (OPF).

$$min {\sum }_{i = 2}^{I} [ O {C}_{i}^{pos} ( {P}_{i}^{pos} ) + O {C}_{i}^{neg} ( {P}_{i}^{neg} ) ] \qquad [ Equation 1 ]$$

$${V}_{i}^{min} \leq {V}_{i} \leq {V}_{i}^{max} , ∀ i$$

$$0 \leq {P}_{i}^{pos} \leq ( {P}_{i}^{max} - {P}_{i}^{opt} ) , ∀ i$$

$$0 \leq {P}_{i}^{neg} \leq ( {P}_{i}^{opt} - {P}_{i}^{min} ) , ∀ i$$

(wherein

$$O {C}_{i}^{pos} ( {P}_{i}^{pos} ) and O {C}_{i}^{neg} ( {P}_{i}^{neg} )$$

respectively denote positive and negative opportunity costs of the i-th bus management unit, Vᵢ denotes a voltage magnitude of the i-th bus management unit, and

$${P}_{i}^{opt} , {P}_{i}^{pos} , and {P}_{i}^{neg}$$

respectively denote reference power, positive flexibility power, and negative flexibility power of the i-th bus management unit, and the equation or condition is satisfied for all i)

The one or more bus management units may be configured to calculate second flexibility power to be allocated to the one or more distributed resource aggregation units so as to satisfy Equation 2 below.

$$min {\sum }_{m = 1}^{{M}_{i}} [ O {C}_{m}^{pos} ( {P}_{m}^{pos} ) + O {C}_{m}^{neg} ( {P}_{m}^{neg} ) ] \qquad [ Equation 2 ]$$

$${\sum }_{m = 1}^{{M}_{i}} ( {P}_{m}^{opt} + {P}_{m}^{pos} - {P}_{m}^{neg} ) , ∀ m$$

$$0 \leq {P}_{m}^{pos} \leq ( {P}_{m}^{max} - {P}_{m}^{opt} ) , ∀ m$$

$$0 \leq {P}_{m}^{neg} \leq ( {P}_{m}^{opt} - {P}_{m}^{min} ) , ∀ m$$

(wherein

$$O {C}_{m}^{pos} ( {P}_{m}^{pos} ) and O {C}_{m}^{neg} ( {P}_{m}^{neg} )$$

respectively denote positive and negative opportunity costs of the m-th distributed resource aggregation unit,

$${\sum }_{m = 1}^{{M}_{i}} ( {P}_{m}^{opt} + {P}_{m}^{pos} - {P}_{m}^{neg} )$$

denotes a power-balance constraint of the i-th bus management unit, and

$${P}_{m}^{opt} , {P}_{m}^{pos} , and {P}_{m}^{neg}$$

respectively denote reference power, positive flexibility power, and negative flexibility power of the m-th distributed resource aggregation unit, m denotes an index of a distributed resource aggregation unit, M denotes a total number of distributed resource aggregation units, and the equation or condition is satisfied for all m from 1 to M.)

According to another exemplary embodiment of the present invention, there is provided a method for managing distributed energy resources using electric vehicles, performed in a computing device including one or more processors and a memory storing one or more programs executable by the one or more processors, the method including: obtaining, by one or more distributed resource aggregation units, flexibility data from a distributed resource management unit including one or more electric vehicle charging stations and generating approximate flexibility data by approximating the obtained flexibility data; obtaining, by one or more bus management units, the approximate flexibility data from the one or more distributed resource aggregation units and calculating flexibility data of a bus based on the obtained approximate flexibility data and pre-stored power data of the bus; obtaining, by an integrated management unit, the flexibility data of the bus from the one or more bus management units and allocating first flexibility power to the one or more bus management units by optimizing the obtained flexibility data of the bus based on a power flow of a distribution grid; calculating, by the one or more bus management units, second flexibility power to be allocated to the one or more distributed resource aggregation units from the first flexibility power allocated by the integrated management unit using Economic Load Dispatch; calculating, by the one or more distributed resource aggregation units, third flexibility power to be allocated to the one or more distributed resource management units by mapping the second flexibility power allocated from the bus management unit to pre-stored approximate flexibility data; and updating, by the one or more distributed resource management units, a charging schedule according to priorities of electric vehicles connected to the distributed resource management unit based on the third flexibility power allocated from the one or more distributed resource aggregation units.

According to embodiments of the present invention, flexibility of a distribution grid may be improved by utilizing electric vehicles as distributed energy resources in a distributed energy resource management system.

### BRIEF DESCRIPTION OF THE DRAWINGS

FIG. 1 is a block diagram illustrating a distributed energy resource management system using electric vehicles according to an exemplary embodiment of the present invention.

FIG. 2 is a diagram for explaining flexibility data according to an exemplary embodiment of the present invention.

FIG. 3 is a diagram illustrating a process of generating approximate flexibility data according to an exemplary embodiment of the present invention.

FIG. 4 is a diagram for explaining a method for managing distributed energy resources using electric vehicles according to an exemplary embodiment of the present invention.

FIG. 5 is a block diagram for illustrating, by way of example, a computing environment including a computing device suitable for use in exemplary embodiments.

### DETAILED DESCRIPTION

Hereinafter, specific embodiments of the present invention will be described with reference to the accompanying drawings. The following detailed description is provided to aid in a comprehensive understanding of the methods, apparatuses, and/or systems described herein. However, this is merely exemplary, and the present invention is not limited thereto.

In describing embodiments of the present invention, where it is determined that a detailed description of a related known technology may unnecessarily obscure the subject matter of the present invention, the detailed description thereof will be omitted. Further, terms to be described below are terms defined in consideration of functions in the present invention and may vary according to the intention or practice of users or operators. Accordingly, definitions of such terms should be made based on the contents throughout the present specification. Terms used in the detailed description are merely for describing embodiments of the present invention and should not be construed as limiting. Unless clearly used otherwise, an expression in a singular form includes the meaning of a plural form. In the present description, expressions such as ‘include’ or ‘comprise’ are intended to designate the presence of stated features, numbers, steps, operations, elements, parts thereof, or combinations thereof, and should not be construed to exclude the presence or possibility of one or more other features, numbers, steps, operations, elements, parts thereof, or combinations thereof in addition to those stated.

In the following description, terms such as ‘transmission,’ ‘communication,’′sending,′ ‘receiving,’ and other terms having similar meanings with respect to a signal or information include not only direct delivery of the signal or information from one component to another component, but also delivery through another component. In particular, stating that a signal or information is ‘transmitted’ or ‘sent’ to one component indicates the final destination of the signal or information and does not mean a direct destination. The same applies to ‘receiving’ of a signal or information. Further, in the present specification, when two or more pieces of data or information are ‘related,’ it means that when one piece of data (or information) is acquired, at least a part of another piece of data (or information) may be acquired based thereon.

Further, terms such as first and second may be used to describe various components, but the components should not be limited by those terms. Such terms may be used for the purpose of distinguishing one component from another component. For example, without departing from the scope of the present invention, a first component may be referred to as a second component, and similarly, a second component may also be referred to as a first component.

Meanwhile, embodiments of the present invention may include a program for causing a computer to perform the methods described in the present specification and a computer-readable recording medium including the program. The computer-readable recording medium may include, alone or in combination, program instructions, local data files, local data structures, and the like. The medium may be specially designed and configured for the present invention, or may be one that is commonly available and used in the field of computer software. Examples of the computer-readable recording medium include magnetic media such as hard disks, floppy disks, and magnetic tapes, optical recording media such as CD-ROMs and DVDs, and hardware devices specially configured to store and execute program instructions, such as ROM, RAM, and flash memory. Examples of the program include not only machine code, such as that produced by a compiler, but also high-level language code that can be executed by a computer using an interpreter or the like.

Further, in the present embodiment, the term ‘~unit’ refers to software and/or a hardware component such as a field programmable gate array (FPGA), or an ASIC, and the ‘~unit’ performs certain roles. However, the ‘~unit’ is not limited to software or hardware. The ‘~unit’ may be configured to reside in an addressable storage medium or may be configured to cause one or more processors to operate. Accordingly, as one example, the ‘~unit’ may include components such as software components, object-oriented software components, class components, and task components, and may include processes, functions, attributes, procedures, subroutines, segments of program code, drivers, firmware, microcode, circuits, data, databases, data structures, tables, arrays, and variables.

Functions provided within components and ‘~units’ may be combined into a smaller number of components and ‘~units’ or may be separated into additional components and ‘~units.’ In addition, the components and ‘~units’ may be implemented to operate one or more CPUs within a device or a secure multimedia card.

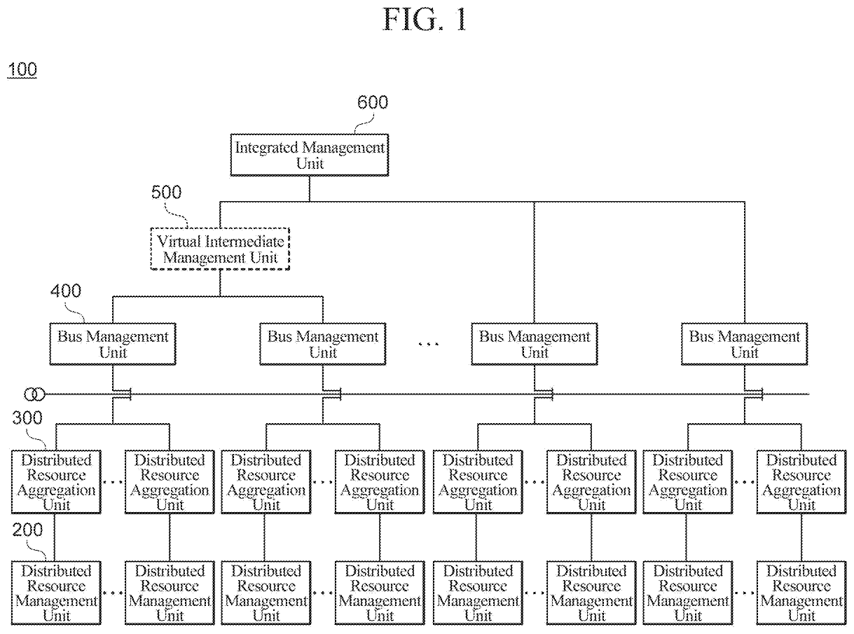

FIG. 1 is a block diagram illustrating a distributed energy resource management system using electric vehicles according to an exemplary embodiment of the present invention.

Referring to FIG. 1, a distributed energy resource management system 100 using electric vehicles according to an exemplary embodiment of the present invention may include a distributed resource management unit 200, a distributed resource aggregation unit 300, a bus management unit 400, and an integrated management unit 600.

Meanwhile, the distributed energy resource management system 100 using electric vehicles according to an exemplary embodiment of the present invention is for improving flexibility of a distribution grid by supporting cooperative operation between distributed resources managed by an existing distributed energy resource management technology and a plurality of electric vehicles (electric vehicle charging stations). That is, the present invention is for applying electric vehicles having inherent flexibility to a distributed energy resource management system, and the present invention will be described on the basis of electric vehicles among distributed resources. At this time, existing distributed resources other than electric vehicles, such as photovoltaic (PV) systems, wind turbines (WTs), energy storage systems (ESSs), and demand resources (DRs), may employ known technologies.

A distributed resource aggregation unit (DER Aggregator) 300 may obtain flexibility data of distributed resources from the distributed resource management unit 200. Here, the distributed resources may be plural and may differ in a form in which energy is produced. For example, the distributed resources may include photovoltaic (PV) systems, wind turbines (WTs), energy storage systems (ESSs), demand resources (DRs), and electric vehicles (EVs), and may also be composed of a combination thereof.

In an exemplary embodiment, the distributed resource aggregation unit 300 may obtain flexibility data from one or more distributed resource management units 200 (for example, electric vehicle charging stations (EVCS)). For example, the distributed resource aggregation unit 300 may obtain flexibility data with respect to one or more distributed resource management units 200 that are connected thereto (managed thereby). Here, the flexibility data of the distributed resource management unit 200 may be cumulative flexibility data accumulated based on priorities of electric vehicles connected to the electric vehicle charging station. Further, the flexibility data may be calculated based on a range of flexibility power (reference power, maximum power, and minimum power at a specific time point) and a cost according to the flexibility power, and may include positive flexibility power, negative flexibility power, positive opportunity cost (OC), and negative opportunity cost. Further, the priority of an electric vehicle may be calculated based on a time at which the electric vehicle started charging at the electric vehicle charging station (arrival time), a requested charging time (desired departure time), and a state of charge (SOC) of a battery of the electric vehicle.

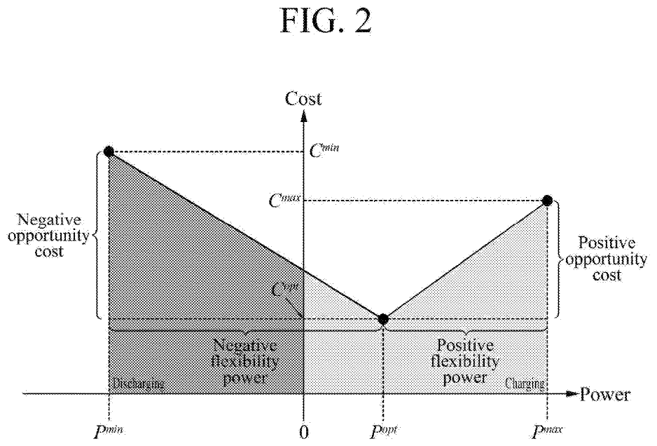

FIG. 2 is a diagram for explaining flexibility data according to an exemplary embodiment of the present invention.

Meanwhile, flexibility may mean an ability to increase or decrease power from a reference power, and may include positive flexibility power for increasing power from the reference power and negative flexibility power for decreasing power from the reference power.

Further, opportunity cost may mean the value of a best alternative foregone when one option is selected, and may include a positive opportunity cost according to provision of positive flexibility power and a negative opportunity cost according to provision of negative flexibility power. The reference power may be a most cost-efficient power value.

In FIG. 2, a light shade and a dark shade may respectively indicate charging and discharging regions. A horizontal axis of the graph indicates a range of flexibility power, and Popt, Pmax, and Pmin respectively indicate reference power, maximum power, and minimum power at a specific time point. A vertical axis of the graph indicates a cost according to flexibility power, and Copt, Cmax, and Cmin respectively indicate costs when Popt, Pmax, and Pmin are applied.

The positive flexibility power may be calculated as a difference between the reference power and the maximum power, and the negative flexibility power may be calculated as a difference between the reference power and the minimum power. Further, the positive opportunity cost, in relation to provision of positive flexibility power, may be calculated as a difference between a cost according to the reference power and a cost according to the maximum power, and the negative opportunity cost may be calculated as a difference between a cost according to the reference power and a cost according to the minimum power. At this time, the cost according to the reference power may mean a fixed cost incurred when charging at the reference power without providing flexibility, and the cost according to the maximum/minimum power may respectively mean a variable cost caused by provision of positive or negative flexibility power.

That is, flexibility data of the electric vehicle charging station may be defined as in Equations 1 to 3 below.

$${P}^{opt} = {\sum }_{r = 1}^{R} {P}_{r}^{opt} \qquad [ Equation 1 ]$$

$${P}^{max} = {\sum }_{r = 1}^{R} {P}_{r}^{max}$$

$${P}^{min} = {\sum }_{r = 1}^{R} {P}_{r}^{min}$$

(wherein Popt, Pmax, and Pmin respectively denote reference power, maximum power, and minimum power of the electric vehicle charging station, r denotes a priority assigned to an electric vehicle, and R denotes a total number of electric vehicles)

Equation 1 indicates a range of flexibility power of the electric vehicle charging station.

$${\hat{P}}^{pos} ( r ) = {\sum }_{ev = 1}^{r} ( {P}_{ev}^{max} - {P}_{ev}^{opt} ) , ∀ r \qquad [ Equation 2 ]$$

$${\hat{P}}^{neg} ( r ) = {\sum }_{ev = 1}^{r} ( {P}_{ev}^{opt} - {P}_{ev}^{min} ) , ∀ r$$

(wherein \hat{P}^{pos}(r) and \hat{P}^{neg}(r) respectively denote cumulative values of positive and negative flexibility power of an electric vehicle having priority r, ev denotes an index for identifying an electric vehicle, and the equation or condition is satisfied for all r.)

Equation 2 indicates flexibility power of the electric vehicle charging station.

$${\hat{O C}}^{pos} ( r ) = {\sum }_{ev = 1}^{r} ( {C}_{ev}^{max} - {C}_{ev}^{opt} ) , ∀ r \qquad [ Equation 3 ]$$

$${\hat{O C}}^{neg} ( r ) = {\sum }_{ev = 1}^{r} ( {C}_{ev}^{opt} - {C}_{ev}^{min} ) , ∀ r$$

(wherein [symbol] ^{pos}(r) and [symbol] ^{neg}(r) respectively denote cumulative values of positive and negative opportunity cost of an electric vehicle having priority r, Copt, Cmax, and Cmin respectively denote costs when Popt, Pmax, and Pmin are applied, and the equation or condition is satisfied for all r.)

Equation 3 indicates opportunity cost of the electric vehicle charging station.

In an exemplary embodiment, the distributed resource aggregation unit 300 may approximate the obtained flexibility data to generate approximate flexibility data. Specifically, the distributed resource aggregation unit 300 may combine flexibility data of each distributed resource management unit 200 and perform filtering, and may approximate the filtered flexibility data to generate approximate flexibility data.

For example, the distributed resource aggregation unit 300 may generate combination data by combining flexibility data of each distributed resource management unit 200 in all possible combinations and may select, from among the generated combination data, combination data having the lowest opportunity cost. That is, because the distributed resource aggregation unit 300 may selectively activate or deactivate flexibility data of a plurality of distributed resource management units 200 under its management to provide various levels of positive flexibility power, all combinations need to be checked in order to evaluate the full range of flexibility. However, among such combination data, some combinations may require a higher opportunity cost even though their flexibility power is the same, or the same result may be repeatedly produced due to duplicated flexibility data. By performing filtering, such inefficient data may be removed. At this time, the distributed resource aggregation unit 300 may additionally select a combination having flexibility power greater than that of the selected combination data among the generated combination data.

Further, the distributed resource aggregation unit 300 may generate approximate flexibility data (approximate flexibility data) by approximating, as a quadratic function (opportunity cost function), a relationship between flexibility power and opportunity cost of the filtered flexibility data. Here, the approximate flexibility data may include a range of flexibility power and coefficients of a negative or positive opportunity cost function. At this time, the negative or positive opportunity cost function may be defined as in Equation 4 below, and each coefficient may be calculated using a least squares method.

$$O {C}_{m}^{pos} ( {P}_{m}^{pos} ) = {a}_{m}^{pos} {P}_{m}^{{pos}^{2}} + {b}_{m}^{pos} {P}_{m}^{pos} + {c}_{m}^{pos} \qquad [ Equation 4 ]$$

$$O {C}_{m}^{neg} ( {P}_{m}^{neg} ) = {a}_{m}^{neg} {P}_{m}^{{neg}^{2}} + {b}_{m}^{neg} {P}_{m}^{neg} + {c}_{m}^{neg}$$

(wherein

$$O {C}_{m}^{pos} ( {P}_{m}^{pos} ) and O {C}_{m}^{neg} ( {P}_{m}^{neg} )$$

respectively denote positive and negative opportunity costs of an m-th distributed resource aggregation unit,

$${P}_{m}^{pos} and {P}_{m}^{neg}$$

respectively denote positive and negative flexibility power of the m-th distributed resource aggregation unit, and

$${a}_{m}^{pos} , {a}_{m}^{neg} , {b}_{m}^{pos} , {b}_{m}^{neg} , {c}_{m}^{pos} , and {c}_{m}^{neg}$$

respectively denote constants for the positive and negative opportunity costs of the m-th distributed resource aggregation unit)

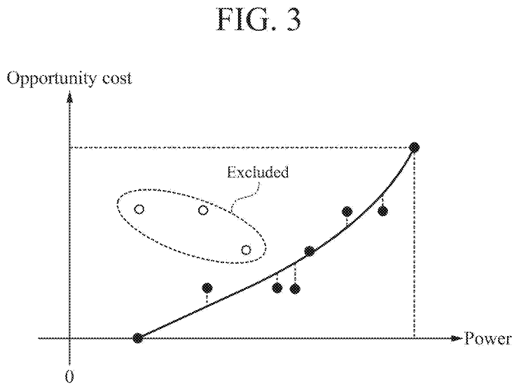

FIG. 3 is a diagram illustrating a process of generating approximate flexibility data according to an exemplary embodiment of the present invention.

In FIG. 3, each point is combination data generated by combining flexibility data of the distributed resource management unit 200. The distributed resource aggregation unit 300 may calculate coefficients of a quadratic function using a least squares method based on selected combination data obtained by filtering the combination data.

A bus management unit 400 may obtain approximate flexibility data from one or more distributed resource aggregation units 300 connected to each line of a bus in a distribution grid, and may calculate flexibility data of the bus based on the obtained approximate flexibility data and pre-stored power data of the bus. At this time, because the bus management unit 400 is connected to an i-th bus in the distribution grid and manages demand power, generation power, and flexibility data of distributed resource aggregation units 300 connected to the i-th bus, flexibility data of the bus may be defined as in Equations 5 and 6 below.

$${P}_{i}^{opt} = {P}_{i}^{D} - {P}_{i}^{G} + {\sum }_{m = 1}^{M} {P}_{m}^{opt} \qquad [ Equation 5 ]$$

$${P}_{i}^{max} = {P}_{i}^{D} - {P}_{i}^{G} + {\sum }_{m = 1}^{M} {P}_{m}^{max}$$

$${P}_{i}^{min} = {P}_{i}^{D} - {P}_{i}^{G} + {\sum }_{m = 1}^{M} {P}_{m}^{min}$$

(wherein

$${P}_{i}^{opt} , {P}_{i}^{max} , and {P}_{i}^{min}$$

respectively denote reference power, maximum power, and minimum power of the i-th bus management unit,

$${P}_{i}^{D}$$

denotes demand (active) power of the i-th bus,

$${P}_{i}^{G}$$

denotes generation (active) power of the i-th bus, m denotes an index of a distributed resource aggregation unit, and M denotes a total number of distributed resource aggregation units)

$$O {C}_{i}^{pos} ( {P}_{i}^{pos} ) = {a}_{i}^{pos} {P}_{i}^{{pos}^{2}} + {b}_{i}^{pos} {P}_{i}^{pos} + {c}_{i}^{pos} \qquad [ Equation 6 ]$$

$$O {C}_{i}^{neg} ( {P}_{i}^{neg} ) = {a}_{i}^{neg} {P}_{i}^{{neg}^{2}} + {b}_{i}^{neg} {P}_{i}^{neg} + {c}_{i}^{neg}$$

(wherein

$$O {C}_{i}^{pos} ( {P}_{i}^{pos} ) and O {C}_{i}^{neg} ( {P}_{i}^{neg} )$$

respectively denote positive and negative opportunity costs of the i-th bus management unit,

$${P}_{i}^{pos} and {P}_{i}^{neg}$$

respectively denote positive and negative flexibility power of the i-th bus management unit, and

$${a}_{i}^{pos} , {a}_{i}^{neg} , {b}_{i}^{pos} , {b}_{i}^{neg} , {c}_{i}^{pos} , and {c}_{i}^{neg}$$

respectively denote constants for the positive and negative opportunity costs of the i-th bus management unit)

Because a process of approximating such flexibility data is the same as described above, a detailed description thereof will be omitted.

Meanwhile, in order to expand the distributed energy resource management system 100 using electric vehicles according to an exemplary embodiment of the present invention so that management and coordination may be performed over a wider area, a virtual intermediate management unit 500 that manages a plurality of bus management units 400 may be further added. At this time, a function of the virtual intermediate management unit 500 may be the same as that of the bus management unit 400.

In the present specification, flexibility power allocated by the integrated management unit 600 to the bus management unit 400 may be referred to as ‘first flexibility power.’ Further, flexibility power calculated by the bus management unit 400 based on the first flexibility power and to be allocated to the distributed resource aggregation unit 300 using Economic Load Dispatch (ELD) may be referred to as ‘second flexibility power.’ Further, flexibility power calculated by the distributed resource aggregation unit 300 by mapping the second flexibility power to pre-stored approximate flexibility data and to be allocated to the distributed resource management unit 200 may be referred to as ‘third flexibility power.’ Accordingly, in the present specification, first flexibility power, second flexibility power, and third flexibility power may be used as terms for distinguishing flexibility power calculated or allocated at different stages in a hierarchical power allocation process.

The integrated management unit 600 may obtain flexibility data of buses from one or more bus management units 400 and may allocate power by optimizing the obtained flexibility data of the buses based on a power flow of a distribution grid.

In an exemplary embodiment, the integrated management unit 600 may allocate power to the bus management unit 400 by optimizing flexibility data of the buses obtained based on a power flow of the distribution grid. For example, the integrated management unit 600 may optimize the obtained flexibility data of the buses using Optimal Power Flow. That is, the integrated management unit 600 may optimize the obtained flexibility data of the buses using Equation 7 below and may allocate flexibility power to the bus management unit 400.

$$min {\sum }_{i = 2}^{I} [ O {C}_{i}^{pos} ( {P}_{i}^{pos} ) + O {C}_{i}^{neg} ( {P}_{i}^{neg} ) ] \qquad [ Equation 7 ]$$

$${V}_{i}^{min} \leq {V}_{i} \leq {V}_{i}^{max} , ∀ i$$

$$0 \leq {P}_{i}^{pos} \leq ( {P}_{i}^{max} - {P}_{i}^{opt} ) , ∀ i$$

$$0 \leq {P}_{i}^{neg} \leq ( {P}_{i}^{opt} - {P}_{i}^{min} ) , ∀ i$$

(wherein

$$O {C}_{i}^{pos} ( {P}_{i}^{pos} ) and O {C}_{i}^{neg} ( {P}_{i}^{neg} )$$

respectively denote positive and negative opportunity costs of the i-th bus management unit, Vᵢ denotes a voltage magnitude of the i-th bus management unit, and

$${P}_{i}^{opt} , {P}_{i}^{pos} , and {P}_{i}^{neg}$$

respectively denote reference power, positive flexibility power, and negative flexibility power of the i-th bus management unit, and the equation or condition is satisfied for all i.)

Equation 7 is an objective function aimed at minimizing positive opportunity costs and negative opportunity costs of all bus management units 600. At this time, the distribution grid may be in a state satisfying power balance. Further, a first bus may be a slack bus.

Further, as in Equation 8 below, power allocated to each bus management unit 400 through optimization by the integrated management unit 600 may be defined.

$${P}_{i}^{allo} = {P}_{i}^{opt} + {P}_{i}^{pos} - {P}_{i}^{neg} \qquad [ Equation 8 ]$$

(wherein

$${P}_{i}^{allo}$$

denotes power allocated to the i-th bus management unit)

Further, the bus management unit 400 may allocate power allocated from the integrated management unit 600 to the distributed resource aggregation unit 300 using Economic Load Dispatch (ELD). That is, the bus management unit 400 may allocate power allocated from the integrated management unit 600 to the distributed resource aggregation unit 300 using Equation 9 below.

$$min {\sum }_{m = 1}^{{M}_{i}} [ O {C}_{m}^{pos} ( {P}_{m}^{pos} ) + O {C}_{m}^{neg} ( {P}_{m}^{neg} ) ] \qquad [ Equation 9 ]$$

$${\sum }_{m = 1}^{{M}_{i}} ( {P}_{m}^{opt} + {P}_{m}^{pos} - {P}_{m}^{neg} ) , ∀ m$$

$$0 \leq {P}_{m}^{pos} \leq ( {P}_{m}^{max} - {P}_{m}^{opt} ) , ∀ m$$

$$0 \leq {P}_{m}^{neg} \leq ( {P}_{m}^{opt} - {P}_{m}^{min} ) , ∀ m$$

(wherein

$$O {C}_{m}^{pos} ( {P}_{m}^{pos} ) and O {C}_{m}^{neg} ( {P}_{m}^{neg} )$$

respectively denote positive and negative opportunity costs of the m-th distributed resource aggregation unit,

$${\sum }_{m = 1}^{{M}_{i}} ( {P}_{m}^{opt} + {P}_{m}^{pos} - {P}_{m}^{neg} )$$

denotes a power-balance constraint of the i-th bus management unit, and

$${P}_{m}^{opt} , {P}_{m}^{pos} , and {P}_{m}^{neg}$$

respectively denote reference power, positive flexibility power, and negative flexibility power of the m-th distributed resource aggregation unit, m denotes an index of a distributed resource aggregation unit, Mi denotes a total number of distributed resource aggregation units, and the equation or condition is satisfied for all m from 1 to M.)

Equation 9 is an objective function aimed at minimizing positive opportunity costs and negative opportunity costs of all distributed resource aggregation units 300.

Further, as in Equation 10 below, power allocated to each distributed resource aggregation unit 300 through the bus management unit 400 may be defined.

$${P}_{m}^{allo} = {P}_{m}^{opt} + {P}_{m}^{pos} - {P}_{m}^{neg} \qquad [ Equation 10 ]$$

(wherein

$${P}_{m}^{allo}$$

denotes power to the m-th distributed resource aggregation unit)

Further, the distributed resource aggregation unit 300 may map power allocated from the bus management unit 400 to pre-stored approximate flexibility data and may allocate flexibility power to each distributed resource management unit 200 (electric vehicle charging station) based on the mapped approximate flexibility data. That is, the distributed resource aggregation unit 300 may select, based on combination data included in the pre-stored approximate flexibility data, combination data having flexibility power identical to or having a smallest difference from the power allocated from the bus management unit 400. Further, the distributed resource aggregation unit 300 may allocate flexibility power to each distributed resource management unit 200 based on the selected combination data. At this time, when the flexibility power of the selected combination data is greater than or equal to the reference power of the distributed resource aggregation unit 300, positive flexibility power may be allocated, and when it is less than the reference power, negative flexibility power may be allocated. That is, when the flexibility power of the selected combination data is greater than or equal to the second flexibility power, the third flexibility power may be allocated as positive flexibility power, and when it is less than the second flexibility power, the third flexibility power may be allocated as negative flexibility power.

Table 1 below is an example of a process of mapping power allocated at the distributed resource aggregation unit 300 to pre-stored approximate flexibility data. In the example below, it is assumed that the distributed resource aggregation unit manages three electric vehicle charging stations (n=1, 2, and 3).

TABLE 1

| | 1st EV | 2nd EV | 3rd EV | |
|---|---|---|---|---|
| Combination | Charging | Charging | Charging | Flexibility |
| Data | Station | Station | Station | Power |
| 1st | 10 kW | 20 kW | 10 kW | 40 kW |
| Combination | | | | |
| 2nd | 25 kW | 20 kW | 10 kW | 55 kW |
| Combination | | | | |
| 3rd | 25 kW | 25 kW | 10 kW | 60 kW |
| Combination | | | | |
| 4th | 25 kW | 25 kW | 20 kW | 70 kW |
| Combination | | | | |

At this time, when power allocated to the distributed resource aggregation unit 300 is 60 kW, combination data having flexibility power identical to or having a smallest difference from the allocated power is third combination data, and thus the third combination data may be selected. Further, because flexibility power of the third combination data is identical to the allocated power, positive flexibility power is allocated to each electric vehicle charging station. That is, 25 kW, 25 kW, and 10 KW corresponding to the third combination data are respectively determined as allocated power for the electric vehicle charging stations.

Meanwhile, the distributed resource management unit 200 may update a charging schedule based on priorities of connected electric vehicles and power allocated from the distributed resource aggregation unit 300. That is, the distributed resource management unit 200 may calculate a priority threshold for providing flexibility power based on the flexibility power allocated from the distributed resource aggregation unit 300 and may provide flexibility power up to the calculated priority threshold. At this time, electric vehicles after the calculated priority threshold may be provided with reference power that does not provide flexibility power. Further, the priority threshold for providing flexibility power may be calculated using an inverse function of a cumulative function (Equation 2) of positive and negative flexibility power of the electric vehicle.

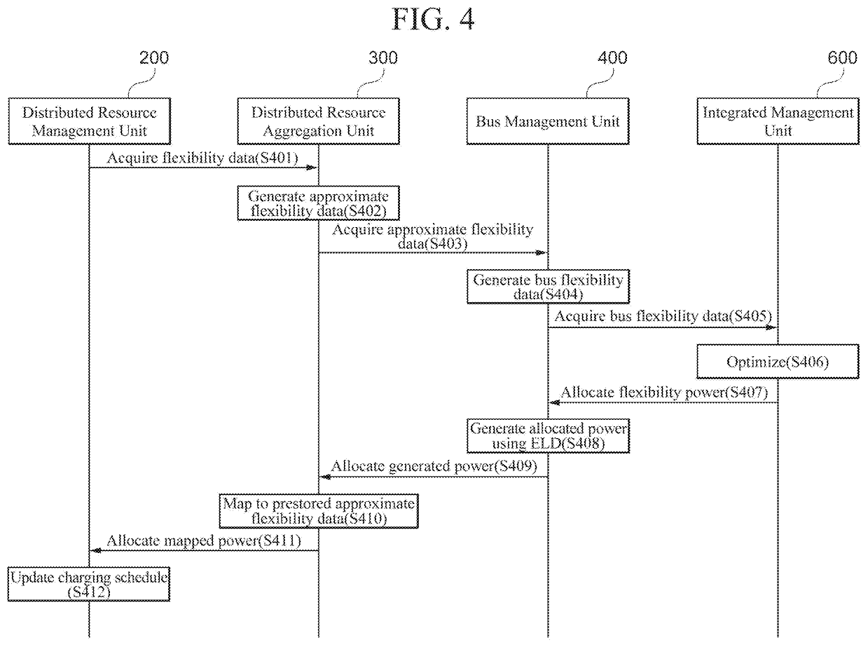

FIG. 4 is a diagram for explaining a method for managing distributed energy resources using electric vehicles according to an exemplary embodiment of the present invention. The method shown in FIG. 4 may be performed, for example, by the above-described distributed energy resource management system using electric vehicles. In the illustrated flowchart, the method is described as being divided into a plurality of operations, but at least some operations may be performed in a changed order, may be performed together in combination with another operation, may be omitted, may be performed while being divided into sub-operations, or one or more operations not shown may be added and performed.

In operation 401, the distributed resource aggregation unit 300 may obtain flexibility data from one or more distributed resource management units. For example, the distributed resource aggregation unit 300 may obtain flexibility data with respect to one or more distributed resource management units 200 that are connected thereto (managed thereby).

In operation 402, the distributed resource aggregation unit 300 may approximate the obtained flexibility data to generate approximate flexibility data. Specifically, the distributed resource aggregation unit 300 may combine flexibility data of each distributed resource management unit 200 and perform filtering, and may approximate the filtered flexibility data to generate approximate flexibility data.

In operation 403, the bus management unit 400 may obtain approximate flexibility data from one or more distributed resource aggregation units 300 connected to each line of a bus in the distribution grid.

In operation 404, the bus management unit 400 may calculate flexibility data of the bus based on the obtained approximate flexibility data and pre-stored power data of the bus.

In operation 405, the integrated management unit 600 may obtain flexibility data of the bus from one or more bus management units 400.

In operation 406, the integrated management unit 600 may optimize flexibility data of the bus obtained based on a power flow of the distribution grid. Specifically, the integrated management unit 600 may optimize flexibility data of the bus obtained based on the power flow of the distribution grid. For example, the integrated management unit 600 may optimize the obtained flexibility data of the bus using Optimal Power Flow.

In operation 407, the integrated management unit 600 may allocate flexibility power to the bus management unit 400.

In operation 408, the bus management unit 400 may calculate power to be allocated to the distributed resource aggregation unit 300 from power allocated by the integrated management unit 600 using Economic Load Dispatch (ELD).

In operation 409, the bus management unit 400 may allocate the calculated power to the distributed resource aggregation unit 300.

In operation 410, the distributed resource aggregation unit 300 may map power allocated from the bus management unit 400 to pre-stored approximate flexibility data. Specifically, the distributed resource aggregation unit 300 may select, based on combination data included in the pre-stored approximate flexibility data, combination data having flexibility power identical to or having a smallest difference from the power allocated from the bus management unit 400.

In operation 411, the distributed resource aggregation unit 300 may allocate flexibility power to each distributed resource management unit 200 based on the mapped approximate flexibility data. Specifically, the distributed resource aggregation unit 300 may allocate flexibility power to each distributed resource management unit 200 based on the selected combination data. At this time, when flexibility power of the selected combination data is greater than or equal to reference power of the distributed resource aggregation unit 300, positive flexibility power may be allocated, and when it is less than the reference power, negative flexibility power may be allocated.

In operation 412, the distributed resource management unit 200 may update a charging schedule based on priorities of connected electric vehicles and power allocated from the distributed resource aggregation unit 300.

Accordingly, according to embodiments of the present invention, flexibility of the distribution grid may be improved by utilizing electric vehicles as distributed energy resources in the distributed energy resource management system.

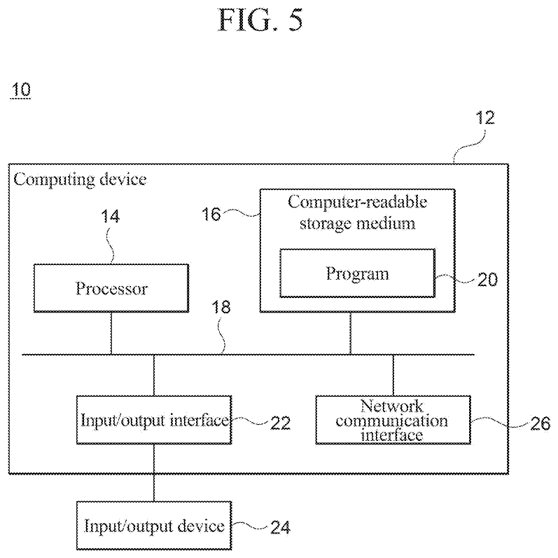

FIG. 5 is a block diagram for illustrating, by way of example, a computing environment 10 including a computing device suitable for use in exemplary embodiments. In the illustrated embodiment, each component may have functions and capabilities different from those described below and may further include additional components in addition to those described below.

The illustrated computing environment 10 includes a computing device 12. In an exemplary embodiment, the computing device 12 may be the distributed resource management unit 200, the distributed resource aggregation unit 300, the bus management unit 400, the virtual intermediate management unit 500, or the integrated management unit 600.

The computing device 12 includes at least one processor 14, a computer-readable storage medium 16, and a communication bus 18. The processor 14 may cause the computing device 12 to operate according to the above-mentioned exemplary embodiments. For example, the processor 14 may execute one or more programs stored in the computer-readable storage medium 16. The one or more programs may include one or more computer-executable instructions, and the computer-executable instructions may be configured, when executed by the processor 14, to cause the computing device 12 to perform operations according to exemplary embodiments.

The computer-readable storage medium 16 is configured to store computer-executable instructions or program code, program data, and/or another suitable form of information. A program 20 stored in the computer-readable storage medium 16 includes a set of instructions executable by the processor 14. In an exemplary embodiment, the computer-readable storage medium 16 may be a memory (volatile memory such as random access memory, non-volatile memory, or a suitable combination thereof), one or more magnetic disk storage devices, optical disk storage devices, flash memory devices, another type of storage medium that can be accessed by the computing device 12 and store desired information, or a suitable combination thereof.

The communication bus 18 interconnects various other components of the computing device 12 including the processor 14 and the computer-readable storage medium 16.

The computing device 12 may further include one or more input/output interfaces 22 providing an interface for one or more input/output devices 24 and one or more network communication interfaces 26. The input/output interfaces 22 and the network communication interfaces 26 are connected to the communication bus 18. The input/output devices 24 may be connected to other components of the computing device 12 through the input/output interfaces 22. Exemplary input/output devices 24 may include input devices such as a pointing device (e.g., a mouse or trackpad), a keyboard, a touch input device (e.g., a touchpad or touchscreen), a voice or sound input device, various types of sensor devices, and/or an imaging device, and/or may include output devices such as a display device, a printer, a speaker, and/or a network card. Exemplary input/output devices 24 may be included inside the computing device 12 as one component constituting the computing device 12, or may be connected to the computing device 12 as a separate device distinct from the computing device 12.

Although representative embodiments of the present invention have been described in detail above, those of ordinary skill in the art to which the present invention pertains will understand that various modifications may be made to the foregoing embodiments without departing from the scope of the present invention. Therefore, the scope of the present invention should not be limited to the described embodiments, but should be defined not only by the claims set forth below but also by equivalents to those claims.

What is claimed is:

1. A distributed energy resource management system using electric vehicles, comprising:
one or more distributed resource aggregation units configured to obtain flexibility data from a distributed resource management unit including one or more electric vehicle charging stations and to generate approximate flexibility data by approximating the obtained flexibility data;
one or more bus management units configured to obtain the approximate flexibility data from the one or more distributed resource aggregation units and to calculate flexibility data of a bus based on the obtained approximate flexibility data and pre-stored power data of the bus; and
an integrated management unit configured to obtain the flexibility data of the bus from the one or more bus management units and to allocate first flexibility power to the one or more bus management units by optimizing the obtained flexibility data of the bus based on a power flow of a distribution grid,
wherein the one or more bus management units calculate second flexibility power to be allocated to the one or more distributed resource aggregation units from the first flexibility power allocated by the integrated management unit using economic load dispatch,
wherein the one or more distributed resource aggregation units calculate third flexibility power to be allocated to the one or more distributed resource management units by mapping the second flexibility power allocated from the bus management unit to pre-stored approximate flexibility data, and
wherein the one or more distributed resource management units update a charging schedule according to priorities of electric vehicles connected to the distributed resource management units based on the third flexibility power allocated from the one or more distributed resource aggregation units.

2. The system of claim 1,
wherein the one or more distributed resource aggregation units are configured to:
generate combination data by combining the obtained flexibility data,
generate filtered flexibility data by selecting, from among the generated combination data, combination data having a lowest opportunity cost; and
generate the approximate flexibility data by approximating a relationship between flexibility power and opportunity cost of the filtered flexibility data as a quadratic function.

3. The system of claim 2,
wherein the one or more distributed resource aggregation units are configured to:
select, based on combination data included in pre-stored approximate flexibility data, combination data having flexibility power identical to or having a smallest difference from the second flexibility power allocated from the bus management unit; and
allocate third flexibility power to the one or more distributed resource management units based on the selected combination data.

4. The system of claim 3,
wherein the one or more distributed resource aggregation units are configured to:
allocate the third flexibility power as positive flexibility power when the flexibility power of the selected combination data is greater than or equal to the second flexibility power; and
allocate the third flexibility power as negative flexibility power when the flexibility power of the selected combination data is less than the second flexibility power.

5. The system of claim 1,
wherein the integrated management unit is configured to optimize the obtained flexibility data of the bus so as to satisfy Equation 1 based on Optimal Power Flow:
$$min {\sum }_{i = 2}^{I} [ O {C}_{i}^{pos} ( {P}_{i}^{pos} ) + O {C}_{i}^{neg} ( {P}_{i}^{neg} ) ] \qquad [ Equation 1 ]$$
$${V}_{i}^{min} \leq {V}_{i} \leq {V}_{i}^{max} , ∀ i$$
$$0 \leq {P}_{i}^{pos} \leq ( {P}_{i}^{max} - {P}_{i}^{opt} ) , ∀ i$$
$$0 \leq {P}_{i}^{neg} \leq ( {P}_{i}^{opt} - {P}_{i}^{min} ) , ∀ i$$
wherein
$$O {C}_{i}^{pos} ( {P}_{i}^{pos} ) , and O {C}_{i}^{neg} ( {P}_{i}^{neg} )$$
respectively denote positive and negative opportunity costs of an i-th bus management unit, Vᵢ denotes a voltage magnitude of the i-th bus management unit, and
$${P}_{i}^{opt} , {P}_{i}^{pos} , and {P}_{i}^{neg}$$
respectively denote reference power, positive flexibility power, and negative flexibility power of the i-th bus management unit, and the equation or condition is satisfied for all i.

6. The system of claim 1,
wherein the one or more bus management units are configured to calculate second flexibility power to be allocated to the one or more distributed resource aggregation units so as to satisfy Equation 2:
$$min {\sum }_{m = 1}^{{M}_{i}} [ O {C}_{m}^{pos} ( {P}_{m}^{pos} ) + O {C}_{m}^{neg} ( {P}_{m}^{neg} ) ]$$
$${\sum }_{m = 1}^{{M}_{i}} ( {P}_{m}^{opt} + {P}_{m}^{pos} - {P}_{m}^{neg} ) , ∀ m$$
$$0 \leq {P}_{m}^{pos} \leq ( {P}_{m}^{max} - {P}_{m}^{opt} ) , ∀ m$$
$$0 \leq {P}_{m}^{neg} \leq ( {P}_{m}^{opt} - {P}_{m}^{min} ) , ∀ m$$
wherein
$$O {C}_{m}^{pos} ( {P}_{m}^{pos} ) , and O {C}_{m}^{neg} ( {P}_{m}^{neg} )$$
respectively denote positive and negative opportunity costs of an m-th distributed resource aggregation unit,
$${\sum }_{m = 1}^{{M}_{i}} ( {P}_{m}^{opt} + {P}_{m}^{pos} - {P}_{m}^{neg} )$$
denotes a power-balance constraint of the i-th bus management unit, and
$${P}_{m}^{opt} , {P}_{m}^{pos} , and {P}_{m}^{neg}$$
respectively denote reference power, positive flexibility power, and negative flexibility power of the m-th distributed resource aggregation unit, and the equation or condition is satisfied for all m from 1 to M.

7. A method for managing distributed energy resources using electric vehicles, performed in a computing device including one or more processors and a memory storing one or more programs executable by the one or more processors, the method comprising:
obtaining, by one or more distributed resource aggregation units, flexibility data from a distributed resource management unit including one or more electric vehicle charging stations and generating approximate flexibility data by approximating the obtained flexibility data;
obtaining, by one or more bus management units, the approximate flexibility data from the one or more distributed resource aggregation units and calculating flexibility data of a bus based on the obtained approximate flexibility data and pre-stored power data of the bus;
obtaining, by an integrated management unit, the flexibility data of the bus from the one or more bus management units and allocating first flexibility power to the one or more bus management units by optimizing the obtained flexibility data of the bus based on a power flow of a distribution grid;
calculating, by the one or more bus management units, second flexibility power to be allocated to the one or more distributed resource aggregation units from the first flexibility power allocated by the integrated management unit using Economic Load Dispatch;
calculating, by the one or more distributed resource aggregation units, third flexibility power to be allocated to the one or more distributed resource management units by mapping the second flexibility power allocated from the bus management unit to pre-stored approximate flexibility data; and
updating, by the one or more distributed resource management units, a charging schedule according to priorities of electric vehicles connected to the distributed resource management unit based on the third flexibility power allocated from the one or more distributed resource aggregation units.

8. The method of claim 7,
wherein the generating of the approximate flexibility data includes:
generating, by the one or more distributed resource aggregation units, combination data by combining the obtained flexibility data;
generating, by the one or more distributed resource aggregation units, filtered flexibility data by selecting, from among the generated combination data, combination data having a lowest opportunity cost; and
generating, by the one or more distributed resource aggregation units, the approximate flexibility data by approximating a relationship between flexibility power and opportunity cost of the filtered flexibility data as a quadratic function.

9. The method of claim 8,
wherein the calculating of the third flexibility power includes:
selecting, by the one or more distributed resource aggregation units, based on combination data included in pre-stored approximate flexibility data, combination data having flexibility power identical to or having a smallest difference from the second flexibility power allocated from the bus management unit; and
allocating, by the one or more distributed resource aggregation units, third flexibility power to the one or more distributed resource management units based on the selected combination data.

10. The method of claim 9,
wherein the allocating of the third flexibility power includes:
allocating, by the one or more distributed resource aggregation units, the third flexibility power as positive flexibility power when the flexibility power of the selected combination data is greater than or equal to the second flexibility power, and allocating the third flexibility power as negative flexibility power when the flexibility power of the selected combination data is less than the second flexibility power.

11. The method of claim 7,
wherein the allocating of the first flexibility power further includes:
optimizing, by the integrated management unit, the obtained flexibility data of the bus so as to satisfy Equation 1 based on Optimal Power Flow:
$$min {\sum }_{i = 2}^{I} [ O {C}_{i}^{pos} ( {P}_{i}^{pos} ) + O {C}_{i}^{neg} ( {P}_{i}^{neg} ) ]$$
$${V}_{i}^{min} \leq {V}_{i} \leq {V}_{i}^{max} , ∀ i$$
$$0 \leq {P}_{i}^{pos} \leq ( {P}_{i}^{max} - {P}_{i}^{opt} ) , ∀ i$$
$$0 \leq {P}_{i}^{neg} \leq ( {P}_{i}^{opt} - {P}_{i}^{min} ) , ∀ i$$
wherein,
$$O {C}_{i}^{pos} ( {P}_{i}^{pos} ) , and O {C}_{i}^{neg} ( {P}_{i}^{neg} )$$
respectively denote positive and negative opportunity costs of an i-th bus management unit, Vᵢ denotes a voltage magnitude of the i-th bus management unit, and
$${P}_{i}^{opt} , {P}_{i}^{pos} , and {P}_{i}^{neg}$$
respectively denote reference power, positive flexibility power, and negative flexibility power of the i-th bus management unit, and the equation or condition is satisfied for all i.

12. The method of claim 7,
wherein the calculating of the second flexibility power further includes:
calculating, by the one or more bus management units, second flexibility power to be allocated to the one or more distributed resource aggregation units so as to satisfy Equation 2:
$$min {\sum }_{m = 1}^{{M}_{i}} [ O {C}_{m}^{pos} ( {P}_{m}^{pos} ) + O {C}_{m}^{neg} ( {P}_{m}^{neg} ) ] \qquad [ Equation 2 ]$$
$${\sum }_{m = 1}^{{M}_{i}} ( {P}_{m}^{opt} + {P}_{m}^{pos} - {P}_{m}^{neg} ) , ∀ m$$
$$0 \leq {P}_{m}^{pos} \leq ( {P}_{m}^{max} - {P}_{m}^{opt} ) , ∀ m$$
$$0 \leq {P}_{m}^{neg} \leq ( {P}_{m}^{opt} - {P}_{m}^{min} ) , ∀ m$$
wherein
$$O {C}_{m}^{pos} ( {P}_{m}^{pos} ) , and O {C}_{m}^{neg} ( {P}_{m}^{neg} )$$
respectively denote positive and negative opportunity costs of an m-th distributed resource aggregation unit,
$${\sum }_{m = 1}^{{M}_{i}} ( {P}_{m}^{opt} + {P}_{m}^{pos} - {P}_{m}^{neg} )$$
denotes a power-balance constraint of the i-th bus management unit, and
$${P}_{m}^{opt} , {P}_{m}^{pos} , and {P}_{m}^{neg}$$
respectively denote reference power, positive flexibility power, and negative flexibility power of the m-th distributed resource aggregation unit, and the equation or condition is satisfied for all m from 1 to M.
